(19) United States
(12) Patent Application Publication
(10) Pub. No.: US 2021/0203650 A1
(43) Pub. Date: Jul. 1, 2021

(54) DATA MESSAGE AUTHENTICATION BASED ON A RANDOM NUMBER

(71) Applicant: HEWLETT-PACKARD DEVELOPMENT COMPANY, L.P., Spring, TX (US)

(72) Inventors: Ingolf BECKER, Bristol (GB); Joshua Serratelli SCHIFFMAN, Bristol (GB)

(73) Assignee: HEWLETT-PACKARD DEVELOPMENT COMPANY, L.P., Spring, TX (US)

(21) Appl. No.: 16/076,540

(22) PCT Filed: Mar. 7, 2017
(86) PCT No.: PCT/US2017/021171

§ 371 Date: Aug. 8, 2018

(51) Int. Cl. H04L 29/06

(52) U.S. Cl. CPC H04L 63/083

(57) ABSTRACT

Examples disclosed herein related to authenticating a data message based on a random number. In one implementation, a first electronic device generates a first random number to associate with a data transaction message and transmits the first random number to a second electronic device identified as the sender of the data transaction message. The first electronic device compares a received authentication message to the first random number to authenticate the sender of the data transaction message. If authenticated, the first electronic device performs a data operation including at least one of: a data access and data update based on the data transaction message.

### BACKGROUND

An authentication method may be used to verify an identity of a user, software application, and/or electronic device. For example, permission to access data, hardware, or an application may be granted after authentication. Authentication methods may analyze, for example, passwords or biometric information. Authentication may be used for different types of applications, such as data storage and retrieval applications.

### BRIEF DESCRIPTION OF THE DRAWINGS

The drawings describe example embodiments. The following detailed description references the drawings, wherein:

FIG. 1A is a block diagram illustrating one example of an electronic device to authenticate a data message based on a random number.

FIG. 1B is a block diagram illustrating one example of a computing system to authenticate a data update request based on a random number.

FIG. 1C is a block diagram illustrating one example of a computing system to authenticate a data access receipt based on a random number.

FIG. 2 is a flow chart illustrating one example of a method to authenticate a data message based on a random number.

FIG. 3 is a flow chart illustrating one example of a method to authenticate a data storage request based on a random number.

FIG. 4 is a diagram illustrating one example of a method to communicate between electronic devices to authenticate a data message to update data based on a random number.

FIG. 5 is a flow chart illustrating one example of a method to authenticate a data access receipt based on a random number.

FIG. 6 is a diagram illustrating one example of a method to communicate between electronic devices to authenticate a data message to access data based on a random number.

### DETAILED DESCRIPTION

In one implementation, an electronic device authenticates a data transaction message based on a random number nonce. For example, the identity of a device sending a data transaction message, such as a message including a data update request or a response to a data access request, may be authenticated using a random number transmitted between the sending and receiving devices. In one implementation, a first electronic device accessing a data transaction message, such as from an anonymous messaging mailbox, may authenticate a second device indicated to be the sender of the data transaction message based on a comparison of a random number sent to an address associated with the indicated sending device and a response from the sending device. For example, the first electronic may generate a first random number to associate with the data transaction message and transmit the first random number to the second device. The first electronic device may compare a received authentication message including a random number to the first random number to authenticate the second electronic device. If authenticated, the first electronic device may perform a data operation, such as an operation to access or update data, based on the instructions in the received data transaction message.

A method to authenticate the sender of a data message may improve the security of communication in a sandbox environment where applications are isolated from one another and communicate via an anonymous mailbox system. The anonymous mailbox system may not establish a bi-directional or long lived communication channel and may rely on messages sent addressable to an application identifier. For example, authenticating the sender of the data message may be used to detect the impersonation of an application in an anonymous mailbox system. Authenticating the source of a message related to data storage and/or retrieval may protect an entity's data where a data service provider maintains accounts or databases for multiple entities and users. For example, a user may have permissions to store or access data associated with a first account but not associated with a second account.

Using a random number to verify the source of a data transaction message may provide greater security for updating data and increased reliability for accessed data. The random number may allow for data related messages to be authenticated on a transaction basis in a convenient manner that may be added to different types of messaging systems and protocols.

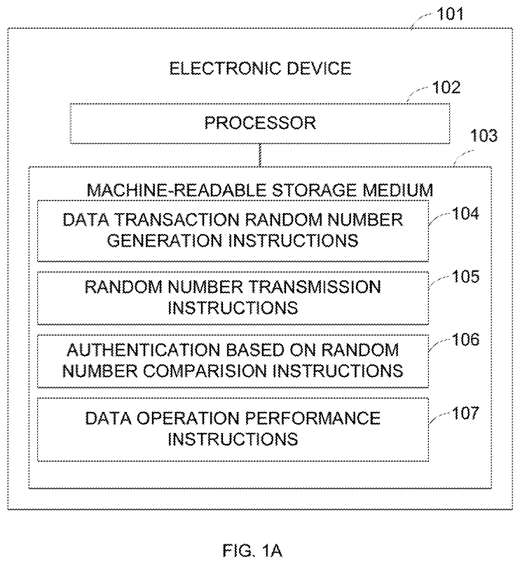

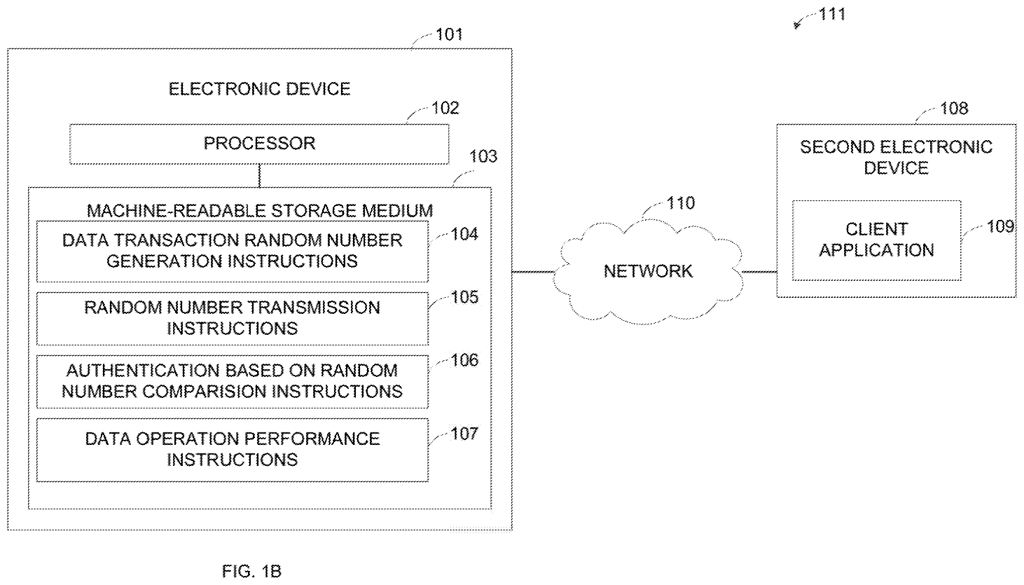

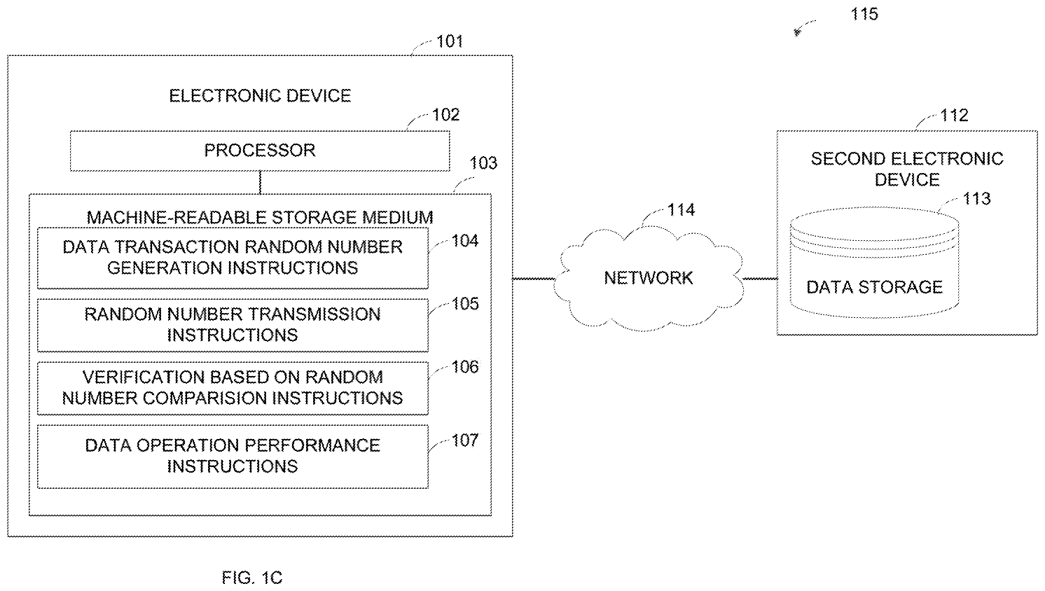

FIG. 1A is a block diagram illustrating one example of an electronic device to authenticate a data message based on a random number. An electronic device 101 may authenticate a data message related to a data operation to update and/or access data based on a random number. The electronic device 101 may transmit information related to a random number to a messaging system associated with the identified source of the data transaction message. The electronic device 101 may authenticate the data transaction message based on a response to the transmitted random number. The electronic device 101 may be any suitable electronic device, such as an electronic device associated with a client running a data application or a data service provider electronic device that stores and/or retrieves data from a data storage. The electronic device 101 may store and process data locally or communicate with a second electronic device for data storage, such as via a network. For example, the electronic device 101 may be part of a cloud service for managing data, or may be a client device for communicating with a cloud service.

In one implementation, the electronic device 101 operates in an anonymous mailbox system environment. For example, each application may have a unique address, and messages may be passed between applications by being addressed to the unique addresses. As an example, the electronic device 101 may retrieve the data transaction message from an anonymous messaging mailbox that includes messages with recipient information.

The electronic device 101 includes a processor 102 and a machine-readable storage medium 103. The processor 102 may be a central processing unit (CPU), a semiconductor-based microprocessor, or any other device suitable for retrieval and execution of instructions. As an alternative or in addition to fetching, decoding, and executing instructions, the processor 102 may include one or more integrated circuits (ICs) or other electronic circuits that comprise a plurality of electronic components for performing the functionality described below. The functionality described below may be performed by multiple processors.

The processor 102 may communicate with the machine-readable storage medium 103. The machine-readable storage medium 103 may be any suitable machine readable medium, such as an electronic, magnetic, optical, or other physical storage device that stores executable instructions or other data (e.g., a hard disk drive, random access memory, flash memory, etc.). The machine-readable storage medium 103 may be, for example, a computer readable non-transitory medium. The machine-readable storage medium 103 may include data transaction random number generation instructions 104, random number transmission instructions 105, authentication based on random number comparison instructions 106, and data operation performance instructions 107.

The data transaction random number generation instructions 104 may include instructions to generate a first random number to associate with a data transaction message. The random number may be any suitable unpredictable identifier to associate with the data transaction message. The data transaction message may be received from a second electronic device in any suitable manner. The data transaction message may include any suitable information, such as a request to store, delete, alter, and/or access data.

The random number transmission instructions 105 may include instructions to transmit the first random number to a second electronic device identified as the sender of the data transaction message. For example, the electronic device 101 may transmit a message including the random number to an anonymous mailbox, such as via a network. The second electronic device may be any suitable electronic device, such as a device executing a client application and/or a device associated with a data service provider. The second electronic device may be an electronic device to store or transmit data and/or to send a request to update or receive data.

The authentication based on random number comparison instructions 106 may include instructions to compare a received authentication message to the first random number to authenticate the sender of the data transaction message. The electronic device 101 may authenticate the source of the data transaction message based on a comparison of the authentication message to the random number. For example, the authentication message may include a random number that is the same as or otherwise correlates to the first random number transmitted to the second electronic device.

The data operation performance instructions 107 may include instructions to perform a data operation based on the data transaction message if the authentication operation is successful. The data operation may be, for example, a data access and/or data update using information included within the data transaction message.

FIG. 1B is a block diagram illustrating one example of a computing system 111 to authenticate a data update request based on a random number. The computing system 111 includes the electronic device 101 from FIG. 1A to authenticate a data transaction message from the second electronic device 108. For example, the electronic device 101 may be a data service provider, and the second electronic device 108 may be a client device with a data storage account with the data service provider. In one implementation, the electronic device 101 is associated with a data service provider that communicates with multiple electronic devices such that date associated with multiple entities is stored in a date storage associated with the electronic device 101. The computing system 111 may include the electronic device 101, a network 110, and the client electronic device 108. The second electronic device 108 may include a client application 109 to access and update data stored by the electronic device 101. The client application 109 may be an application that transmits data to an electronic device to store and/or receives data from an electronic device to access. The electronic device 101 may authenticate a data update request from the second electronic device 108 based on a random number exchanged between the electronic device 101 and the second electronic device 108.

In one implementation, the second electronic device 108 includes a random number generator. For example, the second electronic device 108 may generate a second random number and transmit the second random number to an address associated with the electronic device 101. A second authentication message may be compared to the second random number to authenticate the electronic device 101 such that the second electronic device 108 can confirm the requested data update operation was performed.

FIG. 1C is a block diagram illustrating one example of a computing system to authenticate a data access receipt based on a random number. The computing system 115 includes the electronic device 101 from FIG. 1A to authenticate a data transaction message from the second electronic device 112. For example, the electronic device 101 may be a device that uses a data service provider to store data related to a client application running on the electronic device 101. The computing system 115 may include the electronic device 101, a network 116, and the second electronic device 112. The data second electronic device 112 may be associated with a data service provider and may include or otherwise communicate with a data storage 113. The data storage 113 may store data associated with multiple entities and/or electronic devices. The second electronic device 112 may include a processor to store and retrieve data to and from the data storage 113. The electronic device 101 may authenticate a response to a data access from the second electronic device 112 based on a random number exchanged between the electronic device 101 and the second electronic device 112.

In one implementation, the same device may perform a data storage and data access function. The electronic device may provide a data storage service for a first type of data and utilize a remote data storage service for a second type of data. For example, the same electronic device 101 may function as if in the computing system 111 and as if in the computing system 115 depending on the context of the particular data transaction.

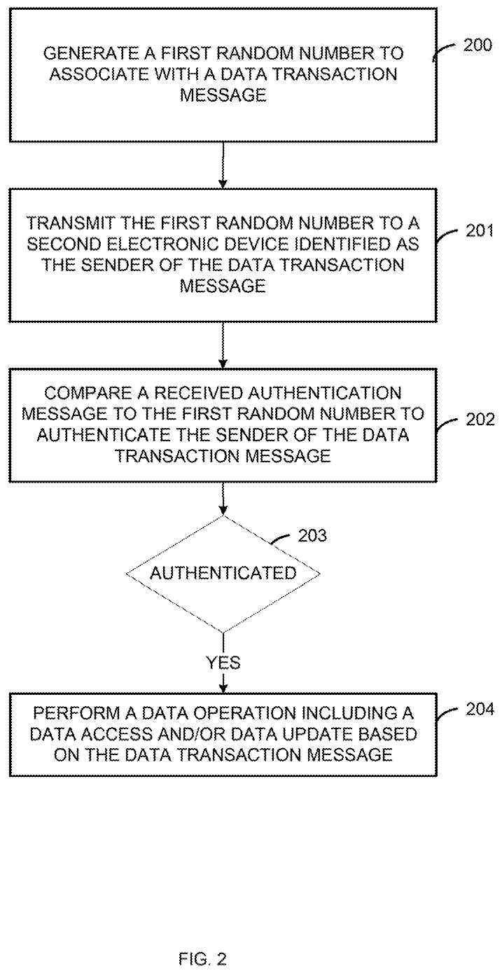

FIG. 2 is a flow chart illustrating one example of a method to authenticate a data message based on a random number. For example, the method may be implemented by an electronic device that stores and retrieves data from a data storage. The electronic device may authenticate a source of a data message including information related to a request to update information in the data storage, such as by adding, deleting, or editing stored data. In one implementation, the method is implemented by an electronic device that receives a response to a request to access stored data, such as where the electronic device is associated with an entity utilizing a data storage cloud service. The method may be implemented, for example, by the computing system of FIGS. 1A, 1B, and/or 1C.

Beginning at 200, an electronic device generates a first random number to associate with a data transaction message. The random number may be any suitable random number to be associated with a data transaction. The electronic device may encrypt or otherwise process the random number. The processor may store the random number to be used for later authentication.

The electronic device may receive or retrieve a message with a data transaction and generate a random number used to authenticate the source of the data transaction message. The message may include a request for a data operation or a communication indicating a device source of a future data transaction message. In one implementation, the processor generates the random number in response to retrieving a message from an anonymous mailbox. The message may include information about the sending client application device. For example, an identifier and/or information that may be used to determine the identifier may be included.

In one implementation, the electronic device determines a unique identifier for communicating between applications where an identifier is unique to a device or user. For example, the electronic device may create a globally unique ID to prevent applications associated with different users from impersonating each other. The electronic device may create a globally unique identifier using a device unique application identifier for a message recipient and augmenting the device unique application identifier with a hash of the public signing key of the recipient device.

Continuing to 201, the electronic device transmits the first random number to a second electronic device identified as the sender of the data transaction message. For example, the electronic device may transmit a message to an anonymous mailbox associated with the second electronic device. The electronic device may determine the identity of the second electronic device based on information accompanying the message including the identity of the client application and/or device sending the data transaction message.

Continuing to 202, the electronic device compares a received authentication message to the first random number to authenticate the sender of the data transaction message. The authentication message may include the random number received from the electronic device. For example, the electronic device may transmit the random number and information about an address for a return authentication message to the second electronic device. The electronic device may authenticate the second electronic device if the first random and a second random number included in the authentication message are the same or otherwise correlate. In some implementations, the electronic device decrypts or performs other processing on the second random number and/or authentication message prior to the comparison.

Continuing to 203, if the second electronic device is authenticated, the method continues to 204. At 204, the electronic device performs a data operation including a data access and/or data update based on the data transaction message. In one implementation, the processor is associated with a data storage provider, and the data operation involves updating stored data associated with an account with update permissions for the second electronic device. In one implementation, the processor is associated with an entity utilizing a shared data storage, and the data operation involves accessing a response to a data access request.

In one implementation, the second electronic device authenticates the data received from the electronic device. For example, the electronic device may receive a second random number from the second electronic device and transmit an authentication message relating to the second random number to an address associated with the second electronic device. The second electronic device may compare the random number sent to the electronic device to the received authentication message to determine that the electronic device sending the data and/or providing status information is the correct device.

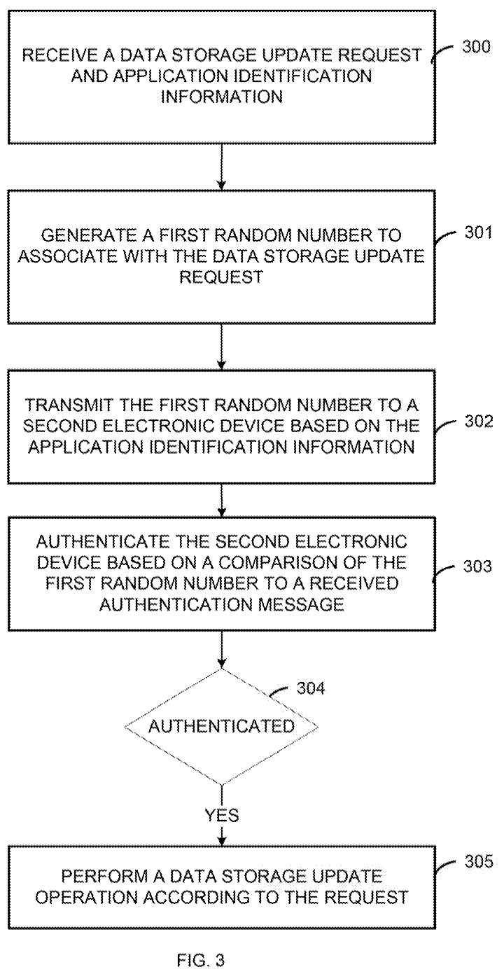

FIG. 3 is a flow chart illustrating one example of a method to authenticate a data storage request based on a random number. The method may be implemented by the electronic device 101 of FIG. 1, such as in the computing system 1B. The method may be implemented by an electronic device for storing data in a data storage. The electronic device may provide a cloud service such that multiple other electronic devices send data to and request data from the electronic device. The electronic device may authenticate a data transaction message based on a random number generated by the electronic device and transmitted to an identifier associated with a second electronic device identified as the sender of the data message. Authentication of the second electronic device may be performed prior to performing the requested data operation, such as operation to store, update, and/or delete data.

In one implementation, the second electronic device requesting the update transmits a second random number to the electronic device and receives an authentication message from the electronic device in response. The second electronic device may use the second random number to authenticate a response to the data request from the electronic device.

Using a random number to authenticate a data request on a per transaction basis may prevent and/or decrease the likelihood of some cyberattacks. For example, the authentication method may prevent attacks substituting a client account ID to perform unauthorized data updates and/or retrieval.

Beginning at 300, the electronic device receives a data storage update request and application identification information. The data storage update request may include a request to access data and/or to store, delete, or alter data. The request may be received from a mailbox associated with the electronic device such that the sending electronic device and the electronic device do not have the ability to communicate directly. For example, a mailbox for receiving a message may improve the security of the messaging system. The data storage update request may include a request to communicate an operation request and/or a request to begin the communication process such that the data operation information may be sent at a later time.

Continuing to 301, the electronic device generates a first random number to associate with the data storage update request. The random number may be generated in any suitable manner. The random number may be generated in response to receiving a data transaction message including the data storage update request.

Continuing to 302, the electronic device transmits the first random number to a second electronic device based on the application identification information. For example, the application identification information may be used directly or used to retrieve recipient identifier information. In one implementation, the electronic transmits a message including the first random number to a mailbox associated with the application.

Continuing to 303, the electronic device authenticates the second electronic device based on a comparison of the first random number to a received authentication message. For example, the electronic device may determine if the first random number and a random number or other contents of the authentication message are the same or otherwise correlate. The electronic device may compare the application identification information to permissions information to verify that the stated user and/or client application has permissions to perform the requested data operation.

Continuing to 304, if the second electronic device is authenticated, the method continues to 305. At 305, the electronic device performs a data storage update operation according to the request.

In one implementation, the electronic device receives a second message from the second electronic device that includes a second random number. The electronic device may transmit the contents of the second message to the second electronic device, such as in a message including data requested or a status update. The second electronic device may use the received information to verify the identity of the electronic device. For example, the second electronic device may terminate the method and/or transmit an error message if the electronic device is not authenticated.

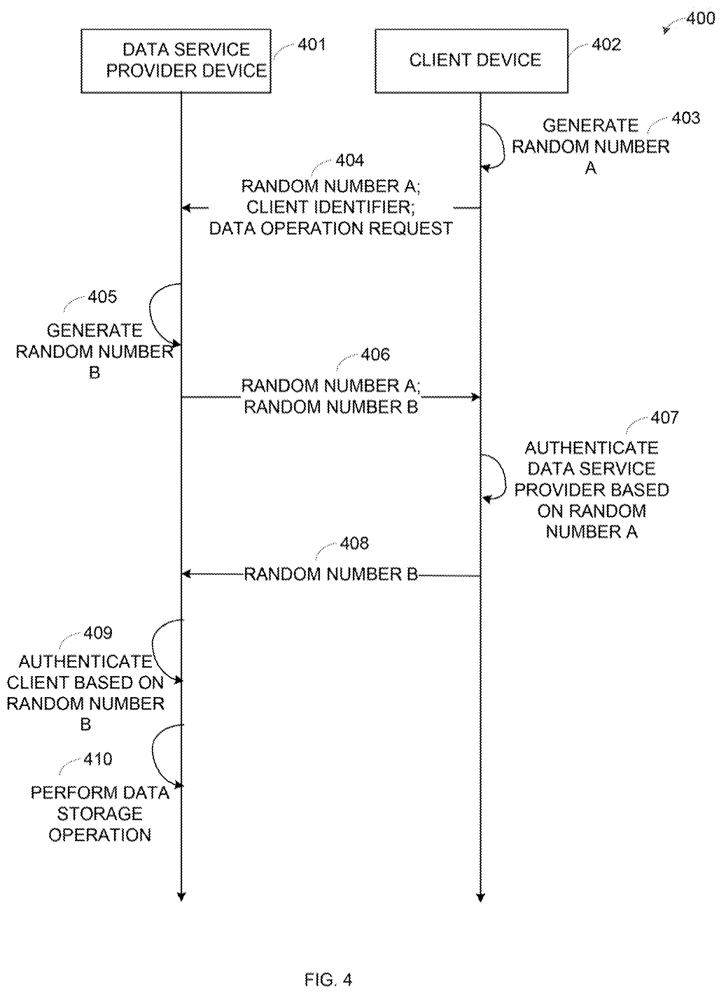

FIG. 4 is a diagram illustrating one example of a method to communicate between electronic devices to authenticate a data message to update data based on a random number. The diagram includes the activity of a data service provider device 401 and a client device 402. The data service provider device 401 and the client device 402 may communicate with one another using an anonymous mailbox system.

Beginning at 403, the client device 402 generates a random number A. The random number A may be generated to associate with a data update request. The random number A may be generated to authenticate the recipient of the data update request.

Continuing to 404, the client device 402 transmits the generated random number A, an identifier associated with the client device, and a data operation request message. The data operation request may include a request to store, update, and/or delete data in a data storage managed by the data service provider device 401. The client device 402 may transmit the information to an anonymous mailbox associated with the data service provider device 401.

Continuing to 405, the data service provider device 401 generates a random number B. The data service provider device 401 may generate the random number B to be used to authenticate the device sending the data storage request.

Continuing to 406, the data service provider 401 transmits random number A and random number B to the client device 402, such as via an anonymous mailbox system. The data service provider 401 may store the received random number A and the generated random number B for later transmission. The data service provider 401 may transmit the information to a destination determined based on the client identifier.

Continuing to 407, the client device 401 may authenticate the data service provider device 401 based on a comparison of the transmitted random number A to a received authentication message including the random number A.

Continuing to 408, the client device 402 transmits the received random number B to the data service provider device 401 using a mailbox or associated with the data service provider device 401. For example, the client device 402 may transmit the random number B to an address determined based on the proclaimed identity of the data service provider 401 transmitting the random number A and B.

Continuing to 409, the data service provider device 401 authenticates the client device 402 based on a comparison of the received random number B to the transmitted and stored random number B. In one implementation, the data service provider device 401 terminates the method if the data service provider if device 402 is not authenticated. For example, the c data service provider device 401 may determine that the client device 402 is not the assumed device.

Continuing to 410, the data service provider device 401 performs a data operation based on the received request from the client device 402 if the client electronic device 402 is authenticated. The operation may include, for example, storing and/or deleting data.

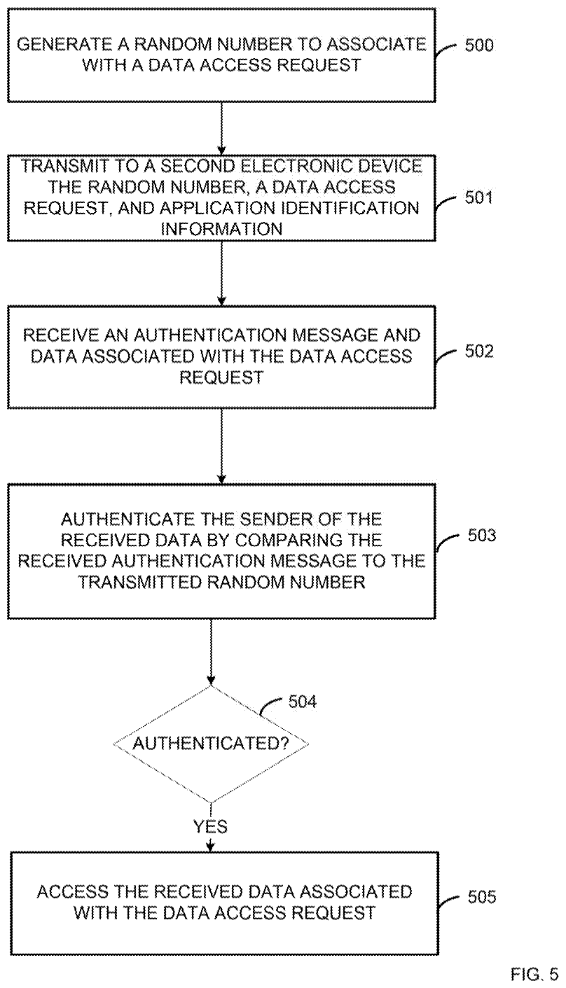

FIG. 5 is a flow chart illustrating one example of a method to authenticate a data access receipt based on a random number. The method may be implemented by a device to request a data operation, such as a request to access stored data. The device may access and utilize received data if the data source is authenticated. In some cases, a method for authenticating data receipt may include fewer steps because a data provider may determine permissions information and limit transmission of data to devices with identifiers associated with data permissions for the requested data. The method may prevent and/or lessen the likelihood of cyberattacks related to a device impersonating a legitimate data service provider and sending false data. The method may be implemented by the electronic device 101 of FIG. 1, such as in the computing system of FIG. 1C.

Beginning at 500, an electronic device generates a random number to associate with a data access request. For example, the random number may be generated to associate with a data request. The electronic device may store the random number such that it may be used to authenticate a received message.

Continuing to 501, the electronic device transmits to a second electronic device the random number, a data access request, and application identification information. The data access request may be a request to access a particular subset of data. The application identification information may include a client name or other information. The application identification information may be used to determine data access permissions and retrieved data destination information. In one implementation, the electronic device transmits the message to anonymous messaging system. For example, a data message including the information may be transmitted to a mailbox associated with the data service provider of the target data source.

Continuing to 502, the electronic device receives an authentication message and data associated with the data access request. For example, the electronic device may retrieve the authentication message and data from a mailbox associated with the electronic device.

Continuing to 503, the electronic device authenticates the sender of the received data by comparing the received authentication message to the transmitted random number. If the authentication message includes a random number that is the same as or otherwise correlates to the random number transmitted, the electronic may determine that the received data associated with the data access request is from the proclaimed sender.

Continuing to 504, if the second electronic device is authenticated, the method continues to 505. At 505, the electronic device accesses the received data associated with the data access request. For example, the client device may store or use the data received from the second electronic device or read a message including the received data.

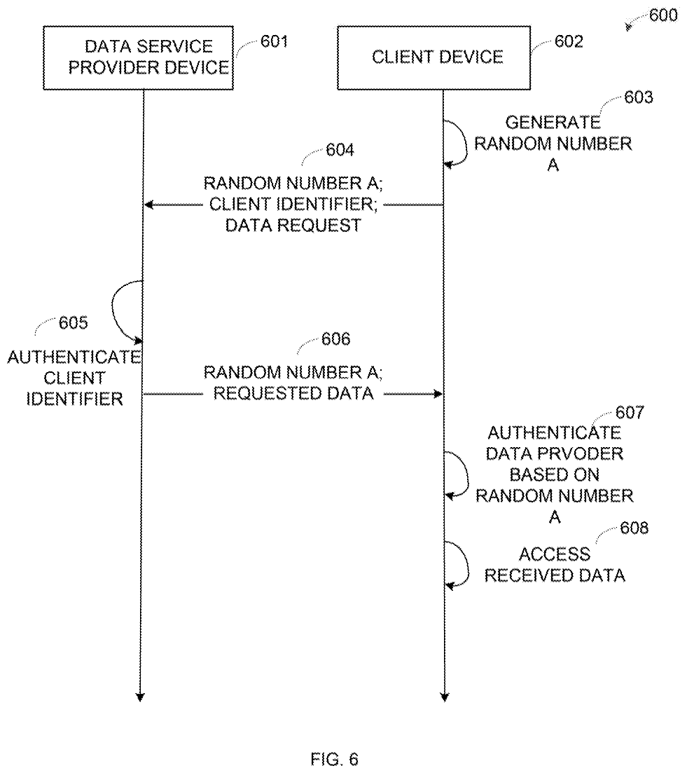

FIG. 6 is a diagram illustrating one example of a method to communicate between electronic devices to authenticate a data message to access data based on a random number. For example, the method 600 may be used to authenticate a message related to data access from a data storage. The method 600 may be performed by a data service provider device 601 and a client device 602.

Beginning at 603, the client device 601 generates a random number A. The random number A may be used to authenticate a data service provider providing data in response to a request such that the authenticity of the received response is verified.

Continuing to 604, the client device 601 transmits the random number, a data request, and a client identifier to a data storage provider device 601. The information may be transmitted in any suitable manner, such as in any combination and in any order.

Continuing to 605, the data service provider device 601 authenticates the client identifier. For example, the data service provider device 601 may determine whether the entity associated with the client has permissions to access the requested data.

Continuing to 606, the data service provider device 601 transmits the requested data and the random number A to the client device 602 if determined that the client device 602 has permissions to access the requested data.

Continuing to 607, the client device 602 authenticates the received data by comparing the received random number A to the transmitted random number A. For example, if the random numbers are the same or otherwise correlate, the client device 602 may determine that the received data is from the expected source.

Continuing to 608, the client device 602 accesses the received data. For example, the client device 602 may utilize the received data. Authenticating data transaction requests and/or responses using random numbers may improve the security and reliability of the data communication.

1. A computing system, comprising:
a first electronic device to:
generate a first random number to associate with a data transaction message;
transmit the first random number to a second electronic device identified as the sender of the data transaction message;
compare a received authentication message to the first random number to authenticate the sender of the data transaction message; and
if authenticated, perform a data operation including at least one of a data access and data update based on the data transaction message.

2. The computing system of claim 1, wherein the first electronic device is associated with a data storage provider and wherein performing a data operation comprises updating stored data.

3. The computing system of 2, wherein the first electronic device is further to:
receive a second random number; and
transmit the second random number to the second electronic device.

4. The computing system of claim 1, wherein the data transaction message includes a response to a data access request and wherein performing the data operation comprises accessing data retrieved from a data storage.

5. The computing system of claim 1, wherein receiving an authentication message comprises accessing an anonymous messaging mailbox associated with the first electronic device.

6. The computing system of claim 1, wherein the first electronic device is further to transmit application identification information to the second electronic device.

7. The computing system of claim 1, wherein the first electronic device is further to create the application identification information based on an aggregation of a device identifier associated with the first electronic device and an application identifier.

8. A method, comprising:
receiving, by a first electronic device, a data storage update request and application identification information;
generating a first random number to associate with the data storage update request;
transmitting the first random number to a second electronic device based on the application identification information;
authenticating the second electronic device based on a comparison of the first random number to a received authentication message; and
if authenticated, performing a data storage update operation according to the request.

9. The method of claim 8, further comprising:
receiving a second authentication message including a second random number; and
transmitting the second authentication message including the second random number to the second electronic device based on the application identification information.

10. The method of claim 9, wherein the second electronic device:
receives the second authentication message:
compares the second authentication message to the second random number; and
determines whether to transmit the first authentication message based on the comparison.

11. The method of claim 8, further comprising determining permissions information associated with the data storage update compared to the application identification information.

12. The method of claim 8, wherein receiving a data storage update request comprises accessing an anonymous mailbox.

13. A machine-readable non-transitory storage medium comprising instructions executable by a processor of a first electronic device to:
generate a random number to associate with a data access request;
transmit to a second electronic device the random number, a data access request, and application identification information;
receive an authentication message and data associated with the data access request;
authenticate the sender of the received data by comparing the received authentication message to the transmitted random number; and
if authenticated, access the received data associated with the data access request.

14. The machine-readable non-transitory storage medium of claim 13, wherein authenticating the sender comprises authenticating a data storage provider with an account associated with the first electronic device.

15. The machine-readable non-transitory storage medium of claim 13, wherein instructions to transmit to a first electronic device comprise instructions to transmit using an anonymous messaging system.
